(19) United States
(12) Patent Application Publication
(10) Pub. No.: US 2012/0026324 A1
(43) Pub. Date: Feb. 2, 2012

(54) IMAGE CAPTURING TERMINAL, DATA PROCESSING TERMINAL, IMAGE CAPTURING METHOD, AND DATA PROCESSING METHOD

(75) Inventor: Ryuichi Kiyoshige, Tokyo (JP)

(73) Assignee: OLYMPUS CORPORATION, Tokyo (JP)

(21) Appl. No.: 13/194,566

(22) Filed: Jul. 29, 2011

(30) Foreign Application Priority Data
Jul. 30, 2010 (JP) 2010-172159

(51) Int. Cl. H04N 7/18; H04N 5/76

(52) U.S. Cl. 348/142; 348/231.3; 348/E05.024

(57) ABSTRACT

An image capturing terminal includes an image capturing unit, a sensor, a calculation unit, and an addition unit. The image capturing unit captures an object and generates an image. The sensor acquires information on a movement from a first image capturing position to a second image capturing position. The calculation unit calculates a relative position of a second image capturing position with reference to the first image capturing position based on the information on movement. The addition unit adds information that indicates the relative position to the image captured in the second image capturing position.

### BACKGROUND OF THE INVENTION

1. Field of the Invention

The present invention relates to a technique of adding information on an image capturing position with respect to a captured image.

Priority is claimed on Japanese Patent Application No. 2010-172159, filed Jul. 30, 2010, the content of which is incorporated herein by reference.

2. Description of Related Art

A user desires to effectively record a photograph as memories of the trip while taking photographs at a user's destination. One solution may be the method of mounting a GPS (Global Positioning System) function on a camera or using an external device such as a GPS logger, acquiring information of a photographing position and then adding the information to the photograph. From GPS information, it is possible to obtain latitude, longitude, and altitude information. Because of this, it may be possible to arrange a photograph on a three-dimensional (3D) map and then can see the photographs together with the map so that can see the photograph effectively.

However, in the case of using a GPS, due to variations in antenna orientation or influence with the location, weather and the like, a radio wave received from a satellite is not able to be stably captured and position information may not be reliably recorded. Because of this, as described in Japanese Unexamined Patent Application, First Publication No. 2003-283977, a method of using an air pressure sensor for recording position information including altitude information even without using a complement of four GPS satellites has been considered.

### SUMMARY

According to a first aspect of the present invention, there is provided an image capturing terminal, which includes an image capturing unit which captures an object and generates an image; a sensor which acquires information on a movement from a first image capturing position to a second image capturing position; a calculation unit which calculates a relative position of the second image capturing position with reference to the first image capturing position based on the information acquired by the sensor; and an addition unit which adds information that indicates the relative position to an image captured in the second image capturing position.

According to a second aspect of the invention, the image capturing terminal may further include a designation unit which designates a first absolute position that corresponds to the first image capturing position; a compute unit which computes a second absolute position based on the first absolute position and the information that indicates the relative position; and an addition unit which adds information that indicates the first absolute position to an image captured in the first image capturing position and adding information that indicates the second absolute position to an image captured in the second image capturing position.

According to a third aspect of the invention, there is provided a data processing terminal, which includes a storage unit which stores a first image captured in a first image capturing position and a second image to which information that indicates a relative position with reference to the first image capturing position is added; a designation unit which designates a first absolute position that corresponds to the first image capturing position; a compute unit which computes a second absolute position based on the first absolute position and the information that indicates the relative position; and an addition unit which adds information that indicates the first absolute position to the first image and adds information that indicates the second absolute position to the second image.

The designation unit of the data processing terminal may include a user interface for a user to designate the absolute position.

According to a fourth aspect of the invention, there is provided an image capturing method, which includes acquiring information on a movement from a first image capturing position to a second image capturing position; generating an image by capturing an object in the second image capturing position; calculating a relative position of the second image capturing position with reference to the first image capturing position based on the information on the movement from the first image capturing position; and adding information that indicates the relative position to the image captured in the second image capturing position.

According to a fifth aspect of the invention, there is provided an image capturing method, which includes generating a first image by capturing an object in a first image capturing position; acquiring information on a movement from the first image capturing position to a second image capturing position; generating a second image by capturing an object in the second image capturing position; calculating a relative position of the second image capturing position with reference to the first image capturing position based on the information on the movement from the first image capturing position; adding information that indicates the relative position to the second image; designating a first absolute position that corresponds to the first image capturing position; computing a second absolute position based on the first absolute position and the information that indicates the relative position; adding information that indicates the first absolute position to the first image; and adding information that indicates the second absolute position to the second image.

According to a sixth aspect of the invention, there is provided a data processing method, which includes designating a first absolute position that corresponds to a first image capturing position; computing a second absolute position based on the first absolute position and information that indicates a relative position with reference to the first image capturing position; adding information that indicates the first absolute position to a first image captured in the first image capturing position; and adding information that indicates the second absolute position to a second image to which information that indicates the relative position is added.

### BRIEF DESCRIPTION OF THE DRAWINGS

FIG. 1 is a block diagram illustrating the configuration of a camera according to an embodiment of the invention.

FIG. 2 is a reference diagram illustrating the concept of measurement of the movement amount according to an embodiment of the invention.

FIG. 3 is a reference diagram illustrating a method of measuring the movement amount when a camera moves according to an embodiment of the invention.

FIG. 4 is a reference diagram illustrating a method of measuring the movement amount when a camera moves according to an embodiment of the invention.

FIG. 5 is a reference diagram illustrating a movement route during photographing according to an embodiment of the invention.

FIG. 6 is a reference diagram illustrating a movement route during photographing according to an embodiment of the invention.

FIG. 7 is a reference diagram illustrating a movement route with vectors during photographing according to an embodiment of the invention.

FIG. 8 is a reference diagram illustrating a method of computing the movement amount during photographing according to an embodiment of the invention.

FIG. 9 is a reference diagram illustrating a method of computing the movement amount during photographing according to an embodiment of the invention.

FIG. 10 is a reference diagram illustrating a method of computing the movement amount during photographing according to an embodiment of the invention.

FIG. 11 is a reference diagram illustrating data that is added to an image according to an embodiment of the invention.

FIG. 12 is a flowchart illustrating an operational procedure of a camera according to an embodiment of the invention.

FIG. 13 is a flowchart illustrating an operational procedure of a camera according to an embodiment of the invention.

FIG. 14 is a flowchart illustrating an operational procedure of a camera according to an embodiment of the invention.

FIG. 15 is a flowchart illustrating an operational procedure of a camera according to an embodiment of the invention.

FIG. 16 is a flowchart illustrating an operational procedure of a camera according to an embodiment of the invention.

FIG. 17 is a flowchart illustrating an operational procedure of a camera according to an embodiment of the invention.

FIG. 18 is a reference diagram illustrating an application screen for making image data being related to an absolute position according to an embodiment of the invention.

FIG. 19 is a reference diagram illustrating an application screen for making image data being related to an absolute position according to an embodiment of the invention.

FIG. 20 is a flowchart illustrating an operational procedure of a camera according to an embodiment of the invention.

FIG. 21 is a flowchart illustrating an operational procedure of a camera according to an embodiment of the invention.

FIG. 22 is a reference diagram illustrating a method for making image data being related to an absolute position according to an embodiment of the invention.

### DETAILED DESCRIPTION OF THE EMBODIMENTS

Hereinafter, embodiments of the present invention will be described with reference to the drawings. The embodiments provide a technique of adding relative position information with high-precision to an image, in which the relative position information is used to calculate an absolute position, and provides a technique of adding second absolute position information with high-precision to an image, in which the second absolute position information is calculated based on first absolute position information and relative position information which is related to the first absolute position.

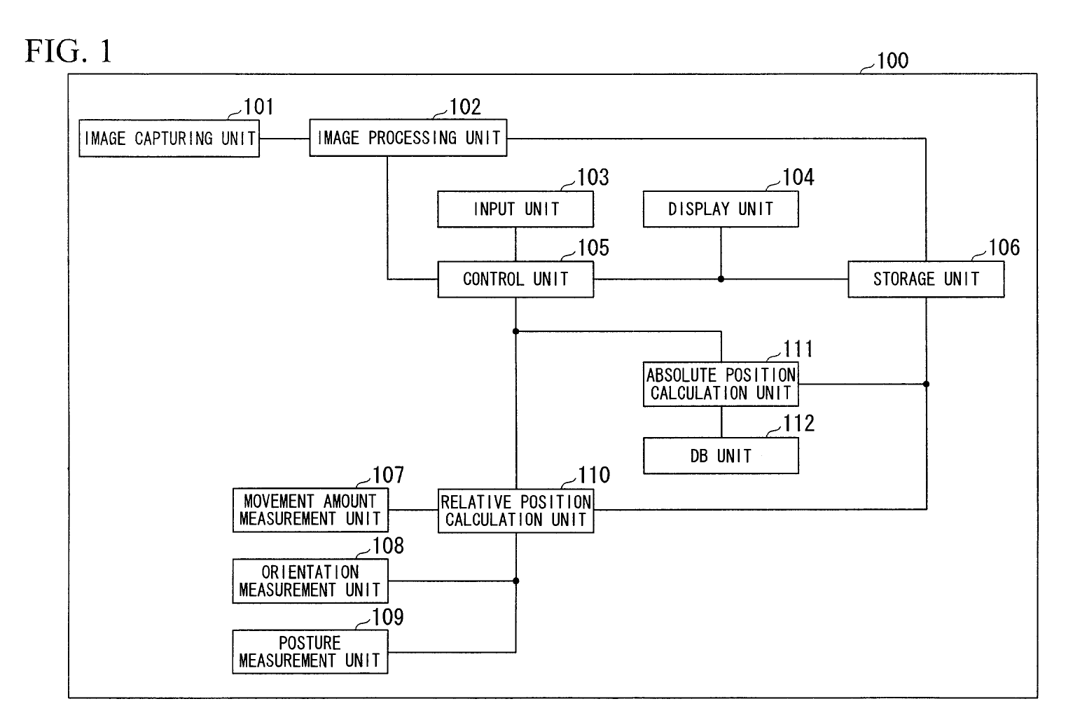

FIG. 1 is a block diagram illustrating the configuration of a camera according to the present embodiment. A camera illustrated in FIG. 1 corresponds to an image capturing terminal and a data processing terminal according to the embodiments of the invention. The camera 100 includes an image capturing unit 101, an image processing unit 102, an input unit 103, a display unit 104, a control unit 105, a storage unit 106, a movement amount measurement unit 107, an orientation measurement unit 108, a posture measurement unit 109, a relative position calculation unit 110, an absolute position calculation unit 111, and a DB unit 112.

The image capturing unit 101 converts object information that is obtained through a lens during photographing into digital data. That is, the image capturing unit 101 captures an object and generates an image. The image processing unit 102 processes the digital data obtained by the image capturing unit 101. The input unit 103 is provided with an interface such as buttons and the like, and receives input from a user. The display unit 104 displays information of the photographed image data or the like, which is recorded in the camera 100, and displays a message or a menu for demanding an operation from the user.

The control unit 105 controls each functions of a camera 100. The storage unit 106 stores the photographed image data and position information that is added to the image data, and stores temporary calculation information for calculating the position information. The movement amount measurement unit 107, for example, is provided with a three-axis acceleration sensor, and measures acceleration of the camera 100 in each axis direction, namely X-axis, Y-axis, and Z-axis, fixed to the camera 100 and displacement (movement distance) of the camera 100.

The orientation measurement unit 108, for example, is provided with a geomagnetic sensor, and measures the orientation. The posture measurement unit 109, for example, is provided with a three-axis angular velocity sensor, and measures a rotation angle per unit time with respect to each axis of the camera 100, that is, X-axis, Y-axis, and Z-axis, of the camera 100. The relative position calculation unit 110 calculates a relative position from a reference point based on the data measured by the movement amount measurement unit 107, the orientation measurement unit 108, and the posture measurement unit 109.

The absolute position calculation unit 111 performs calculation to convert the relative position calculated by the relative position calculation unit 110 into an absolute position (geo tag) based on map information recorded in the DB unit 112. The DB unit 112 stores map data that includes terrain or latitude and longitude information.

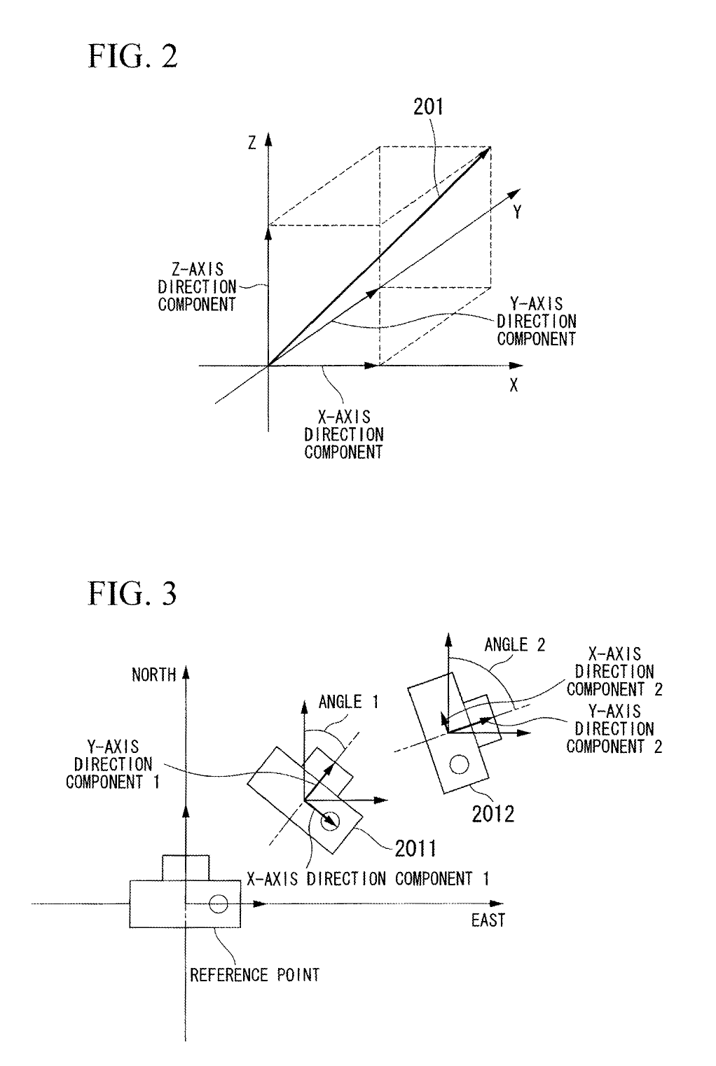

Next, a method of obtaining relative position information with reference to (on the basis of) the reference point will be described. FIG. 2 illustrates the concept of measurement information that is obtained by the movement amount measurement unit 107. The movement amount measurement unit 107 uses a three-axis acceleration sensor, and measures the movement amount in each axis direction, namely, X-axis, Y-axis, and Z-axis, when the camera 100 moves in a certain direction. The acceleration sensor detects the acceleration (speed change per second) of the sensor itself in each axis direction.

If it is assumed that the camera 100 has moved in a movement direction 201 as illustrated in FIG. 2, the movement amount measurement unit 107 detects a movement distance in each axis direction from the acceleration in each axis direction, namely X-axis, Y-axis, and Z-axis. In the case of using the camera 100, it is not considered that the posture of the camera 100 is kept constant. Due to this, it is necessary to correct the movement distance in each axis direction according to the posture change of the camera.

FIG. 3 illustrates a method of measuring the movement amount in each axis direction in the case where the camera 100 moves while it changes its posture. In this case, for ease of understanding, two axes (two dimensions) are expressed. However, there is no change in the way and method even in the case of three axes (three dimensions).

First, it is necessary to set a reference point for the camera 100 before measuring the movement amount. In an example in the drawings, the optical axis direction of the camera 100 is directed to the north at the reference point. The relative position calculation unit 110 calculates the direction to which the camera 100 is directed based on the orientation that is measured by the orientation measurement unit 108 and the acceleration in the Z-axis direction (that is, Z-axis direction component of gravitational acceleration) that is measured by the movement amount measurement unit 107. The direction to which the camera 100 is directed is stored in a storage unit 106 as the posture information at the reference point.

Then, when a predetermined unit time has elapsed; the camera 100 moves to a position 2011.

In this position 2011, the movement amount measurement unit 107 and the posture measurement unit 109 perform their measurements, respectively.

Here, in comparison to the direction to which the camera 100 is directed which is measured at the reference point, the direction to which the camera 100 is directed is changed by an angle 1. By converting the change amount of the posture of the camera 100 caused by the movement into the movement amount in each axis direction, it becomes the X-axis direction component 1, the Y-axis direction component 1, and the Z-axis direction component 1 (not shown in the drawing). The movement amount measurement unit 107 measures the movement amount in each axis direction. The movement amount corresponds to a movement amount in a case where it is assumed that the camera 100 has moved from the reference point to the position 2011 while the angle 1 is constant. Further, the posture measurement unit 109 measures the rotation angle (angle 2 in the drawing) with respect to each axis cased by the movement.

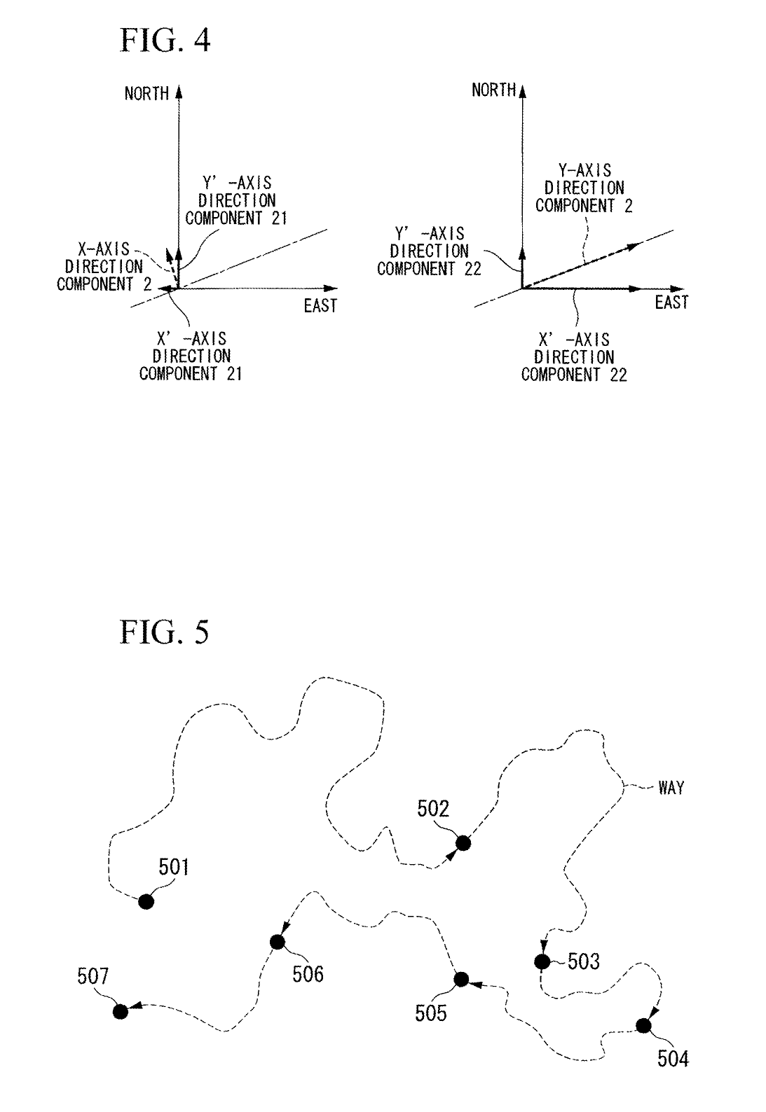

Even in the case where the unit time has elapsed after the measurement is performed in the position 2011 and the camera 100 moves to the position 2012, each measurement unit performs its measurement in the same manner as the case where the camera 100 moves to the position 2011. If the posture of the camera 100 is changed as shown in FIG. 3, the movement amount in each axis direction may not be used as the position information as it is, the conversion for measuring the movement amount is performed as shown in FIG. 4.

FIG. 4 illustrates a method of computing the movement amount when a camera 100 moves to a position 2012 in FIG. 3. Since the camera 100 measures the posture at each movement point, the posture change amount with respect to the reference point can be obtained. The east, west, north and south directions at the reference point are known by the orientation measurement. Since the acceleration sensor can detect the gravitational acceleration as generally known, the upward and downward directions at the reference point can be known.

The relative position calculation unit 110 applies movement amounts in each axis direction at each movement point to a space having axes in east and west direction, north and south direction, and upward and downward direction, and calculates the movement amounts in the east and west direction, north and south direction, and upward and downward direction by resolving each direction component. FIG. 4 shows a method for resolving an X-axis direction component 2 and a Y-axis direction component 2 into north and south direction components (Y′-axis direction component 21 and Y′-axis direction component 22) and east and west direction components (X′-axis direction component 21 and X′-axis direction component 22) when the camera moves from the position 2011 to the position 2012 shown in FIG. 3. As a result, the movement amounts at the position 2012 may be represented as follows.

Movement amount 2 in north and south direction=Y′-axis direction component 21+Y′-axis direction component 22

Movement amount 2 in east and west direction=X′-axis direction component 21+X′-axis direction component 22

The relative position calculation unit 110 adds the movement amounts that are calculated from the result of the measurement at each movement point by the above-described calculation method. That is, the movement amounts from the reference point in a space having axes in east and west direction, north and south direction, and upward and downward direction are obtained in the following equations (N=optionally determined).

Movement amount in north and south direction=movement amount 1 in north and south direction+movement amount 2 in north and south direction+ . . . +movement amount N in north and south direction

Movement amount in east and west direction=movement amount 1 in east and west direction+movement amount 2 in east and west direction+ . . . +movement amount N in east and west direction

Movement amount in upward and downward direction=movement amount 1 in upward and downward direction+movement amount 2 in upward and downward direction+ . . . +movement amount N in upward and downward direction

Next, a case where a user takes photographs while wandering about tourist resorts will be described. FIG. 5 expresses a movement route (way). As illustrated in FIG. 5, a user takes photographs at various points through freely moving about at random. Specifically, as illustrated in FIG. 5, the user first takes a photograph at a photographing position 501, next takes a photograph at a photographing position 502, and so on. Hereinafter, for ease of the explanation, the expression will be made in two axes (two dimensions).

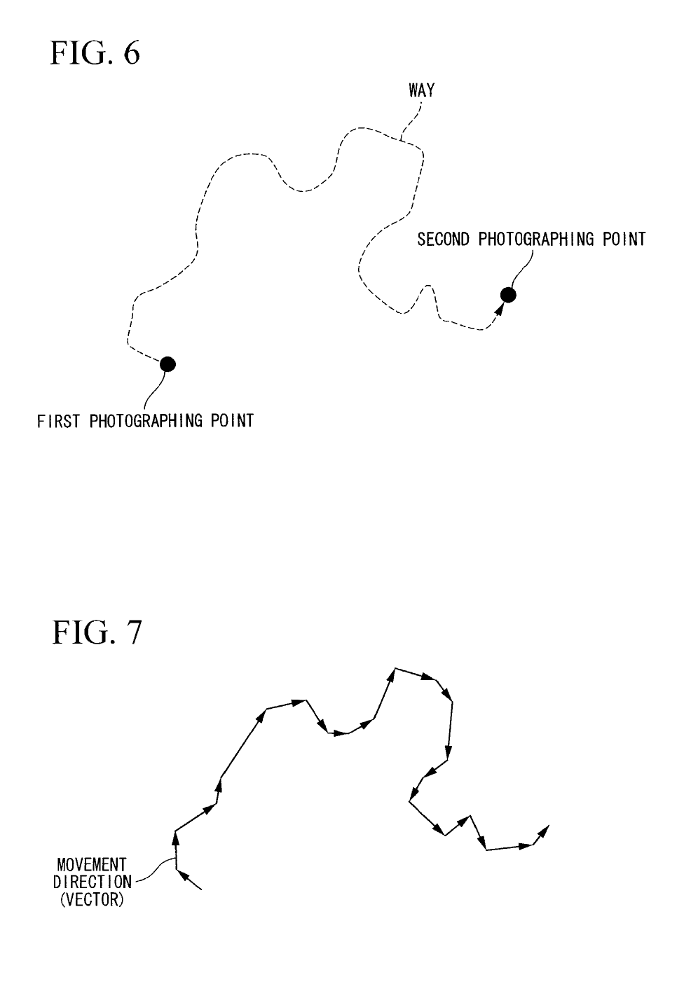

FIG. 6 illustrates a way taken from the photographing position 501 to the photographing position 502 in FIG. 5. FIG. 7 illustrates an image in which the movement amount (vector) is measured per unit time.

Although the movement direction per unit time is illustrated in FIG. 7, the object is to acquire relative position information of the photographing position, and in this case, it only has to know the relative distance from the photographing position 501 to the photographing position 502.

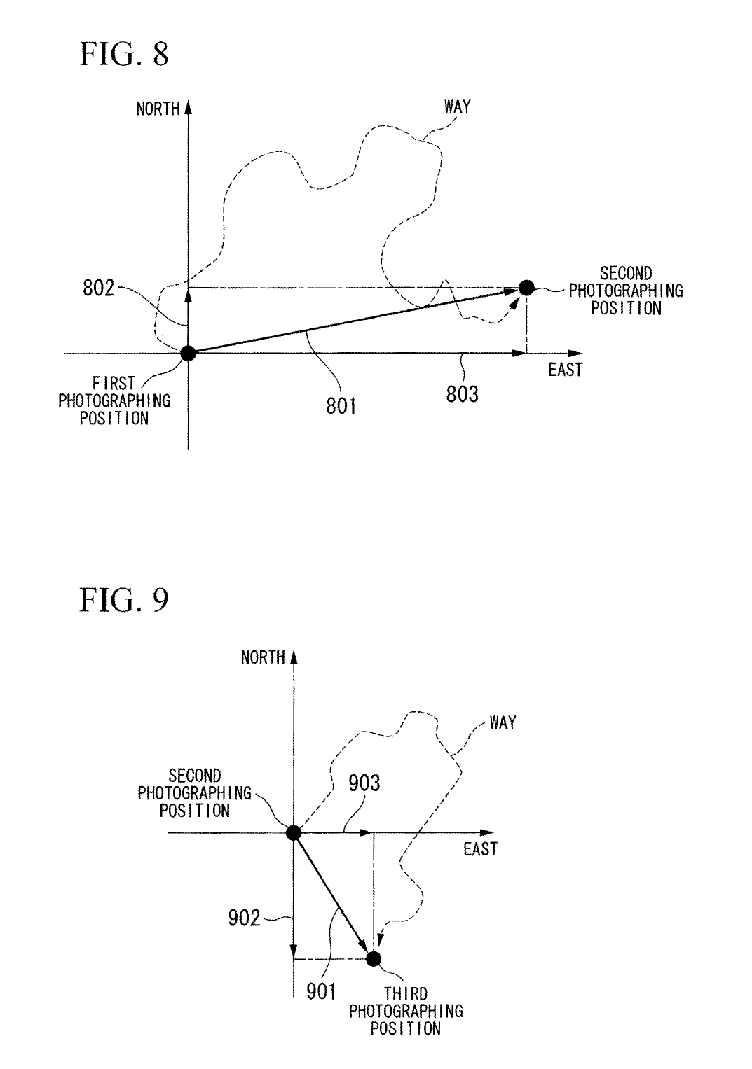

FIG. 8 illustrates a relative position of the second photographing position (photographing position 502) from a first photographing position (photographing position 501). A user takes a photograph in the first photographing position, and considers this point as the reference point as described above. Along the way, the camera 100 continuously computes the movement amount by measuring the movement amount and the posture. Here, when reaching the second photographing position, the user performs the photographing. In this case, the camera determines a relative position (coordinates) of a second photographing position with reference to the first photographing position from the movement amount calculated until then. Although the way itself is long and irregular, the movement direction from the first photographing position to the second photographing position may be expressed as a movement direction 801, and the movement (distance) in the north and south direction and the movement (distance) in the east and west direction, which are caused by the movement, may be a movement amount 802 in the north and south direction and a movement amount 803 in the east and west direction.

FIG. 9 expresses a relative position when the camera 100 moves from the second photographing position (photographing position 502) to the third photographing position (photographing position 503). The movement direction from the second photographing position when the camera 100 reaches a third photographing position is a movement direction 901, and a movement amount (distance) in the north and south direction and a movement amount (distance) in the east and west direction are a movement amount 902 in the north and south direction and a movement amount 903 in the east and west direction, respectively. Considering the second photographing position (photographing position 502) as the above-described reference point, the movement amount from the second photographing position (photographing position 502) to the third photographing position (photographing position 503) is calculated.

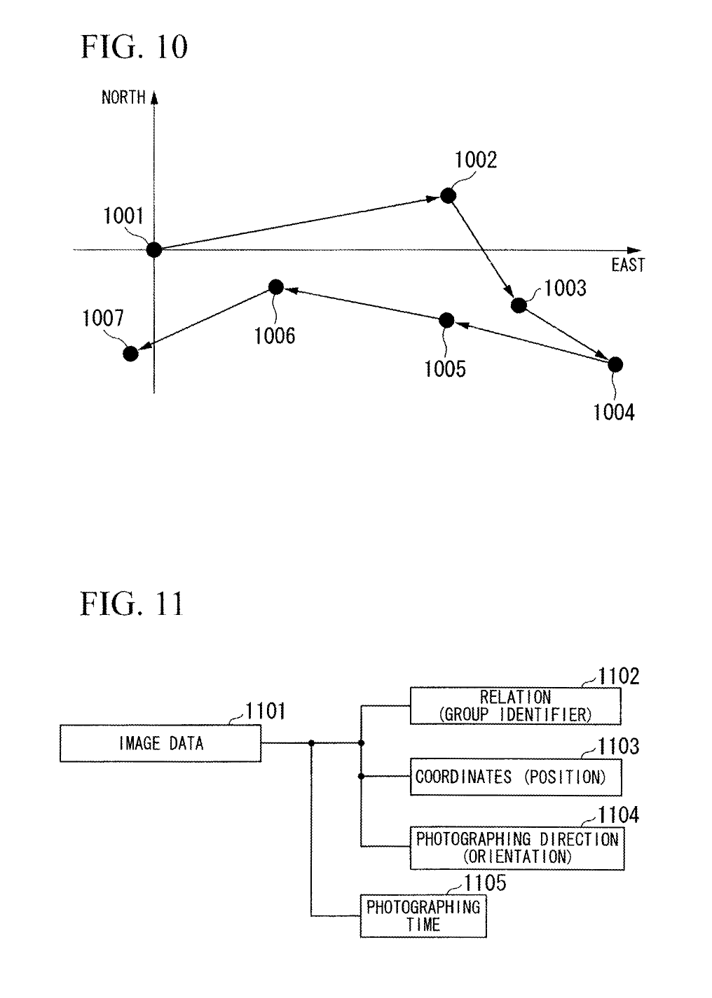

Thereafter, by obtaining a fourth photographing position (photographing position 504) and a fifth photographing position (photographing position 505) in the same manner, as illustrated in FIG. 10, coordinates 1001, 1002, . . . , and 1007 are calculated. Although the coordinates are expressed in two axes (two dimensions) in FIG. 10, coordinates (X, Y, Z) in three axes (three dimensions) can be actually calculated.

Next, information that is added to a photographed image will be described. FIG. 11 illustrates data that is added to an image. To image data 1101, relation (group identifier) 1102 for managing the photographing positions 501 to 507 explained using FIGS. 5 and 10 as one group, coordinates (position) 1103 calculated as described above, a photographing direction (orientation) 1104 obtained by measurement through the orientation measurement unit 108 during photographing, and a photographing timing 1105 for specifying the order of photographing with respect to an image data group that is managed by the relation (group identifier) 1102 are added.

<First Example, in the Case where Absolute Position Information (Geo Tag) Cannot Be Acquired>

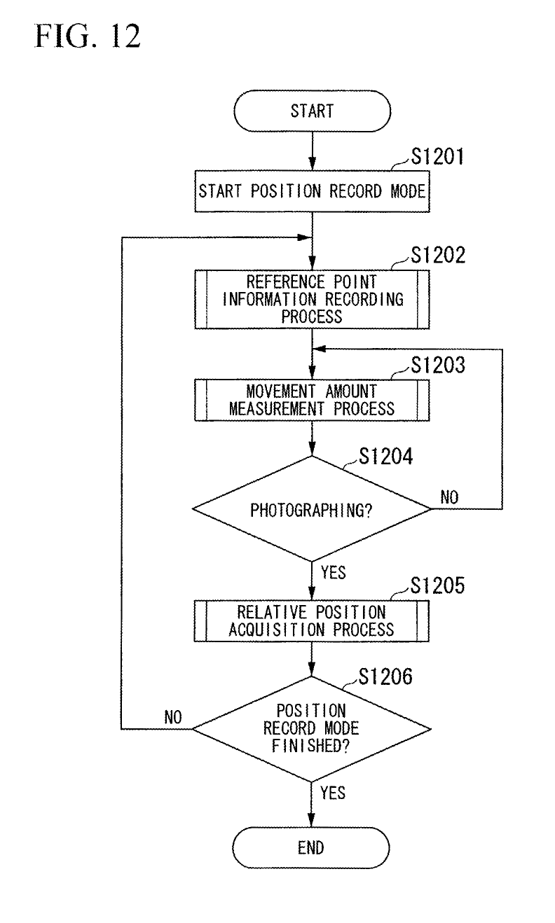

FIGS. 12 to 15 to be described hereinafter show calculations based on the contents described using FIGS. 2 to 11. First, FIG. 12 will be described.

In order to acquire the relative position during photographing, the camera 100 initially starts a position record mode (step S1201). This position record mode is a mode that is installed on the assumption to perform typical photographing with no position record, and in the case where the camera is configured to constantly record the position, step S1201 is not specially required.

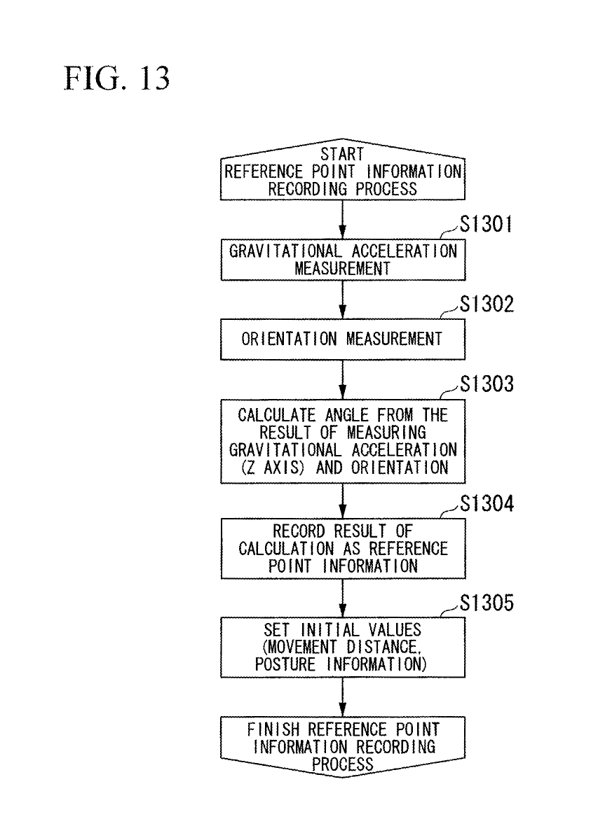

Then, the camera 100 performs recording of reference point information. FIG. 13 shows the details of reference point information recording.

First, the movement amount measurement unit 107 measures acceleration (Z-axis direction component of gravitational acceleration) in the Z-axis direction of the camera 100 (step S1301), and the orientation measurement unit 108 measures the orientation (step S1302). Then, the relative position calculation unit 110 calculates a difference (angle) between X-axis, Y-axis, and Z-axis directions of the camera 100 and east and west, north and south, and upward and downward directions based on the result of the measurement performed by the movement amount measurement unit 107 and the result of the measurement performed by the orientation measurement unit 108 (step S1303). The relative position calculation unit 110 stores the result of the calculation in the storage unit 106 as reference point information (step S1304). Further, the relative position calculation unit 110 initializes the movement amount (distance) and posture information (step S1305). This initialization means to set each parameter (the movement amount and the posture) to “0” (“0” point). By performing such processes, the reference point information can be set.

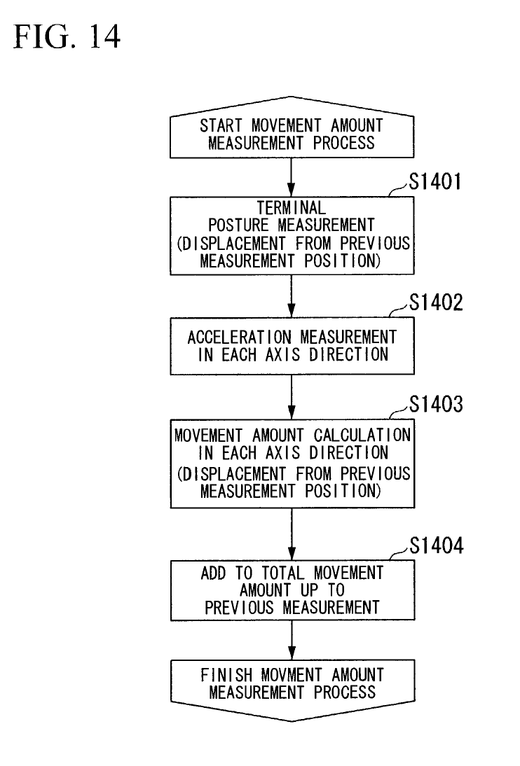

After performing the reference point information recording process, the camera 100 performs a movement amount measurement process (step S1203). FIG. 14 shows the details of the movement amount measurement process.

First, the posture measurement unit 109 measures the posture of the camera 100 (step S1401). This means measuring the displacement of rotating angles of the X-axis, Y-axis, and Z-axis from the last measured point after recording the reference point information. The posture information to be measured is a displacement after the last measurement time.

By integrating the displacement of the rotating angles up to the present measurement time, the displacement of the rotating angle from the reference point can be measured.

Then, the movement amount measurement unit 107 measures the acceleration in each axis direction, namely X-axis, Y-axis, and Z-axis (step S1402). Then, the relative position calculation unit 110 calculates the movement amount (distance) in each axis direction, namely east and west, north and south, and upward and downward directions based on the information obtained in steps S1401 and S1402. This calculation method is the same as that described using FIGS. 3 and 4.

Further, the relative position calculation unit 110, as illustrated in FIG. 4, calculates the movement amounts (distances) in each axis direction from the reference point, that is, coordinates (relative position) having the reference point as the original point, by adding the movement amounts (distances) in each axis direction calculated in step S1403 to the total movement amounts (distances) in each axis direction up to the last measurement time after recording the reference point information (which are set to “0” during the initial measurement after recording the reference point information) for each axis direction respectively (step S1404). Through these processes, the movement amounts can be measured.

If a user's photographing instruction is input to the input unit 103 after the movement amounts are measured in step S1203, the camera 100 performs the photographing (step S1204). Further, in the case where the user's photographing instruction is not input to the input unit 103, the camera 100 performs the movement amount measurement again (step S1203). This repetition time (unit time) may be optionally determined. For example, the movement amount after the last measurement may be measured once for every 0.5 seconds.

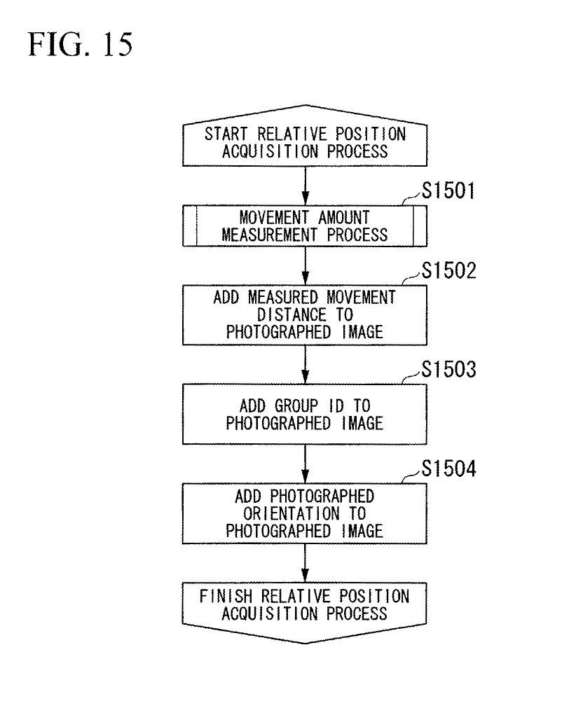

After the photographing, the camera 100 performs the relative position acquisition process in order to obtain the distance (coordinates) of the photographing point from the reference point (step S1205). FIG. 15 shows the details of the relative position acquisition process.

First, just after the photographing, the camera 100 measures the movement amount as described with reference to FIG. 14 (step S1501). Then, the control unit 105 adds the movement amount (coordinates) measured in step S1501 to the photographed image data (step S1502). At this time, in order to make the continuous photographing actions from the reference point be related to one another, the control unit 105 adds the relation (group identifier (group ID)) as illustrated in FIG. 11 (step S1503). Further, the control unit 105 adds the photographing orientation of the camera 100 that is obtained from the difference of angles between the orientation obtained by the orientation measurement unit 108 and the optical axis directions of the camera 100 to the photographed image data (step S1504). Through these processes, the photographing position (coordinates) with reference to the reference point (photographing position 501) can be calculated. The image data added with various kinds of information is stored in the storage unit 106.

In the case of continuing the performance in the position record mode after the relative position acquisition process, the camera 100 performs the reference point information recording process in step S1202 again. However, in the case of discontinuing the performance in the position record mode, it finishes the performance in the position record mode.

<Second Example, in the Case where the Absolute Position Information (Geo Tag) is can be Acquired>

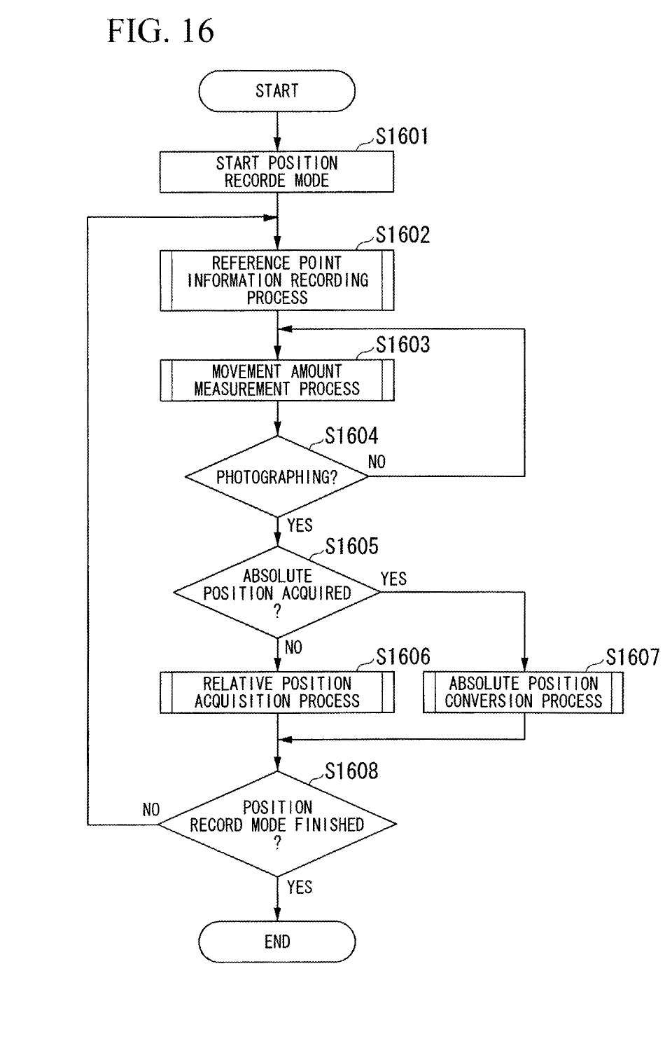

From the foregoing, the method of acquiring the relative position in consideration of the first photographing position as the reference point (base point) has been described. However, a case where the camera 100 has unit for acquiring the absolute position information will now be described using FIG. 16. Since the process illustrated in FIG. 16 is not greatly changed from the process of acquiring the relative position illustrated in FIG. 12, only the differences between them will be described.

Start of a position record mode (step S1601), reference point information recording process (step S1602), movement amount measurement process (step S1603), and photographing (step S1604) are not changed with respect to the processes illustrated in FIG. 12. Thereafter, the control unit 105 determines whether or not to acquire the absolute position (step S1605).

Here, the unit for acquiring the absolute position does not matter. For example, the absolute position may be acquired by GPS, since the photographed image may show a characteristic (famous) building and the location of the building is clear, a method for acquiring a geo tag of the location of a building in a database inside the camera 100 may be used. In the case where the absolute position cannot be acquired, the camera 100 performs relative position acquisition process (step S1606). This is no substitute for the process illustrated in FIG. 15.

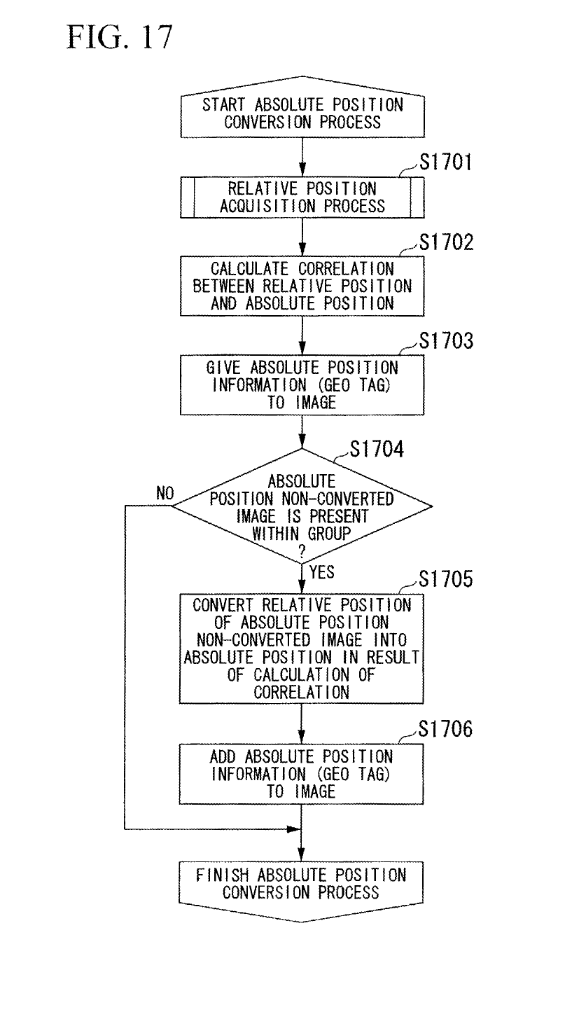

On the other hand, in the case where the absolute position can be acquired through the above-described method, the camera 100 performs absolute position conversion process (step S1607). The absolute position conversion process is a process that adds the absolute position information (geo tag) to the photographed image data and converts the relative position information that is added to the previously photographed image data into absolute value position (geo tag) information. The absolute position conversion process will be described using FIG. 17.

First, the camera 100 acquires the relative position in consideration of the photographing position 501 as the reference point (base point) (step S1701). This process is performed since it is necessary to derive the difference between the current photographing position and the last photographing position. Then, the absolute position calculation unit 111 designates the acquired absolute position, and calculates the correlation between the relative position and the absolute position (step S1702). This is only to simply combine the relative position information with the absolute position information. That is, the relationship that the three-dimensional coordinates (X, Y, Z) of the relative position is L degrees east longitude, M degrees north latitude, and N degrees altitude (where L, M, and N are optional) is temporary stored in the storage unit 106 of the camera 100.

After calculating the relationship between the relative position and the absolute position, the absolute position calculation unit 111 adds the absolute position information that indicates the designated absolute position to the image data (step S1703). At this time, the relative position information that is added in the relative position acquisition process (step S1701) is also left in the image data. Due to this, the coordinates (position) 1103 described in FIG. 11 include the relative position and the absolute position.

Then, the absolute position calculation unit 111 searches for image data having the same relation (group identifier) 1102 as that of the image data just after the photographing from image data stored in the storage unit 106, and determines whether or not the absolute position is recorded in the image data (step S1704).

If the absolute position is recorded in the whole image data found in the search, the camera 100 finishes the absolute position conversion process. On the other hand, if image data of which the absolute position information is not recorded is present in the image data found in the search, the absolute position calculation unit 111 converts the relative position of the image data to the absolute position from the relationship between the relative position and the absolute position and the distance between the relative positions by using a method of calculating the distances using the absolute position information (geo tag) between two points which are generally known (step S1705).

Hereinafter, the details of the process in step S1705 will be described. The relative position of each photographing position with reference to a certain photographing position can be obtained from the relative position information added to the respective image data. For example, although the relative position of the photographing position 502 in FIG. 5 is with reference to the photographing position 501 and the relative position of the photographing position 503 is with reference to the photographing position 502, the relative position of the photographing position 503 with reference to the photographing position 501 can be obtained by calculating the relative position of the photographing position 502 and the relative position of the photographing position 503.

Hereinafter, it is assumed that the photographing position that corresponds to the designated absolute position is the first photographing position and the photographing position that is the subject intended to calculate the absolute position is the second photographing position. In step S1705, the absolute position calculation unit 111 calculates the relative position of the second photographing position with reference to the first photographing position from the relative position information added to the respective image data as described above. Then, the absolute position calculation unit 111 calculates the absolute position of the second photographing position based on the calculated relative position information and the absolute position information.

Hereinafter, two methods of calculating the absolute position will be described. The first calculation method is a method that calculates the absolute position in a simple calculation method without considering the surface shape of the earth on the assumption that the method is used in a zone where photographing spots are closely provided. The absolute position calculation unit 111 calculates the absolute position of the second photographing position in the following equation based on the designated absolute position and the relative position of the second photographing position calculated as described above.

Absolute position (latitude) to be obtained=designated absolute position (latitude)+(north and south direction components of the relative position/length of circumference of the earth (on meridian)×360)

Absolute position (longitude) to be obtained=designated absolute position (longitude)+(east and west direction components of the relative position/length of circumference of the earth (on equator)×360)

Absolute position (altitude) to be obtained=designated absolute position (altitude)+(upward and downward direction components of the relative position)

The second calculation method, for example, is open to the public in http://vldb.gsi.go.jp/sokuchi/surveycalc/algorithm/. This method uses a conversion method of plane rectangular coordinates [symbol] latitude and longitude. First, the absolute position calculation unit 111 converts the designated absolute position (latitude and longitude) into plane rectangular coordinates (x, y). Then, the absolute position calculation unit 111 calculates the absolute position (planer rectangular coordinates) of the second photographing position based on the plane rectangular coordinates (x, y) and the relative position of the second photographing position. Then, the absolute position calculation unit 111 converts the absolute position (plane rectangular coordinates) of the second photographing position into the absolute position (latitude and longitude) of the second photographing position. The altitude can be obtained in the same manner as the first calculation method. The above description corresponds to the contents of the process in step S1705.

Then, the absolute position calculation unit 111 adds the obtained absolute position information (geo tag) to the image data (step S1706). Through the above-described processes, it becomes possible to convert the relative position into the absolute position if the absolute position can be acquired in the midst of the photographing.

<Third Example, Method of Recording an Absolute Position>

In the first example as described above, acquisition of the absolute position is not considered when the photographing is performed. In a generally known photograph arrangement application, it is known to record the position information on an image by mapping the image on the map through a user's operation after photographing.

In this embodiment, by reporting the absolute position information (geo tag) with respect to one image among associated (grouped) images after photographing, the absolute position information (geo tag) is recorded to all other associated images without troubling user's hand. Hereinafter, the method will be described.

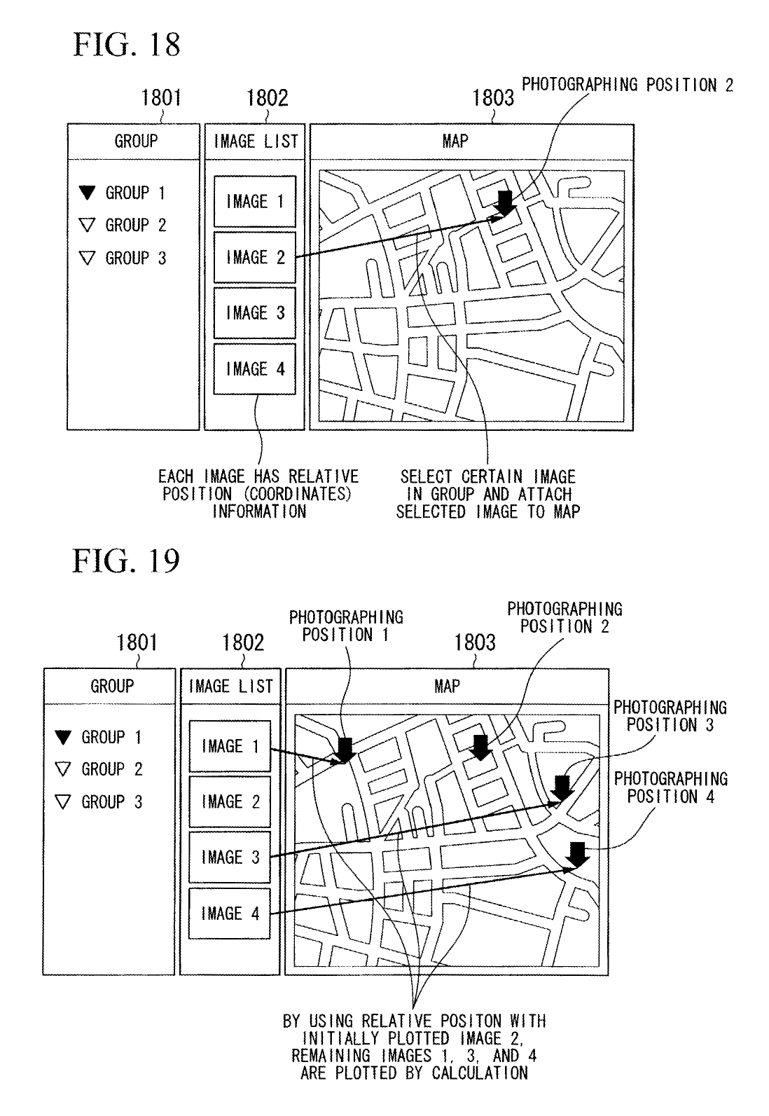

FIG. 18 shows an example of an application screen for relating image data to an absolute position. Although it is assumed that this application is mounted inside the camera 100, it is also assumed that this application is processed by an external device (personal computer). Hereinafter, as an example, the operation in the case where the application is mounted inside the camera 100 will be described.

This application includes a group list region 1801 managing the relation (group) of images, an image list region 1802 list displaying an image group that belongs to a certain group, and a map region 1803 capable of mapping the image on a map. For example, if a user selects image 2 and arranges the image 2 to a selected appropriate position (place where the photograph is taken) on the map region 1803, as illustrated in FIG. 18, other images (image 1, image 3, and image 4) are also arranged on appropriate positions (places where the photographs are taken) on the map region at the same time, and the absolute position information (geo tag) determined in the respective points on the map is added to the image data, as illustrated in FIG. 19.

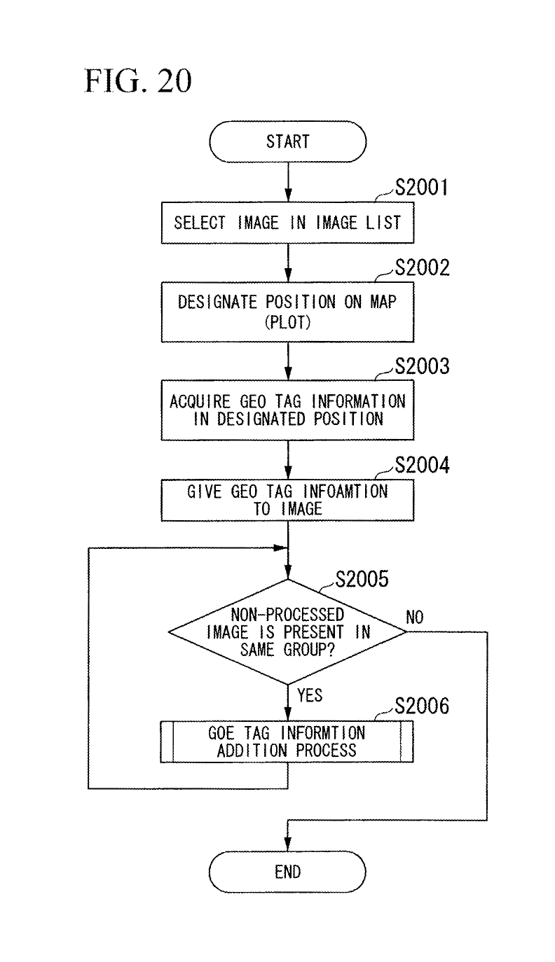

These processes will be described using FIG. 20. First, the control unit 105 selects an image from the image list region 1802 based on the user's instruction input to the input unit 103 (step S2001). Then, the control unit 105 designates an appropriate position (place where the photograph is taken) in the map region 1803 for arranging the selected image based on the user's instruction input to the input unit 103 (step S2002).

Then, the control unit 105 acquires the absolute position information (geo tag) of the designated position from the DB unit 112 (step S2003), and adds the absolute position information (geo tag) to the image arranged in step S2002 (step S2004). Through the above-described process, the absolute position information (geo tag) can be added to the image initially arranged on the map.

Then, the control unit 105 searches for an image of which the absolute position is not recorded in the associated image group (images in the same group) (step S2005). If an image of which the absolute position is not recorded is not found, the process is finished as it is. On the other hand, if an image of which the absolute position is not recorded is present, the control unit 105 performs absolute position information (geo tag) addition process (step S2006).

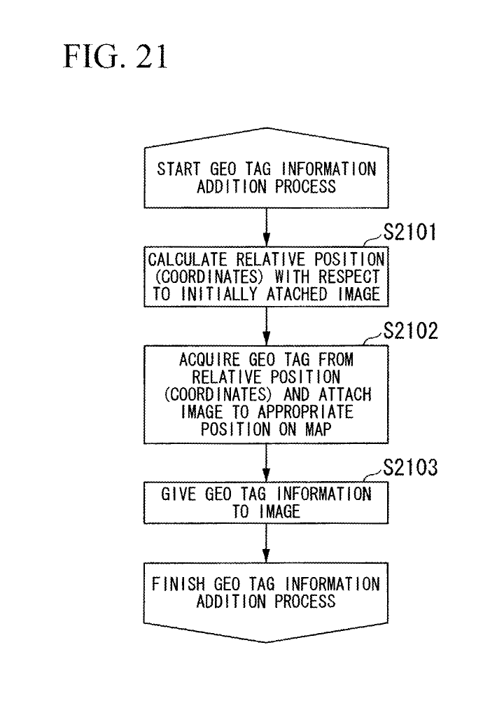

The absolute position information addition process will be described using FIG. 21. First, the control unit 105 calculates the relative position (coordinates) between the image found in the process in step S2005 and the image initially arranged on the map (step S2101). This is a reconverted relative position in consideration of the relative position (coordinates) of the initially arranged image as the reference point (base point).

Then, the control unit 105 calculates the absolute position which is added to the image that is found in the process in step S2005 based on the obtained relative position (coordinates) and the absolute position which is indicated by the absolute position information (geo tag) that is added to the image initially arranged on the map, and arranges the image in an appropriate position on the map that corresponds to the absolute position (step S2102). Then, the control unit 105 adds the acquired absolute position information (geo tag) to the image (step S2103).

Through the above-described processes, the absolute position information (geo tag) can be added to the image in the same group. These processes are performed until no image of which the absolute position is not recorded remains in the same group.

<Application of an Absolute Position Information Addition Method>

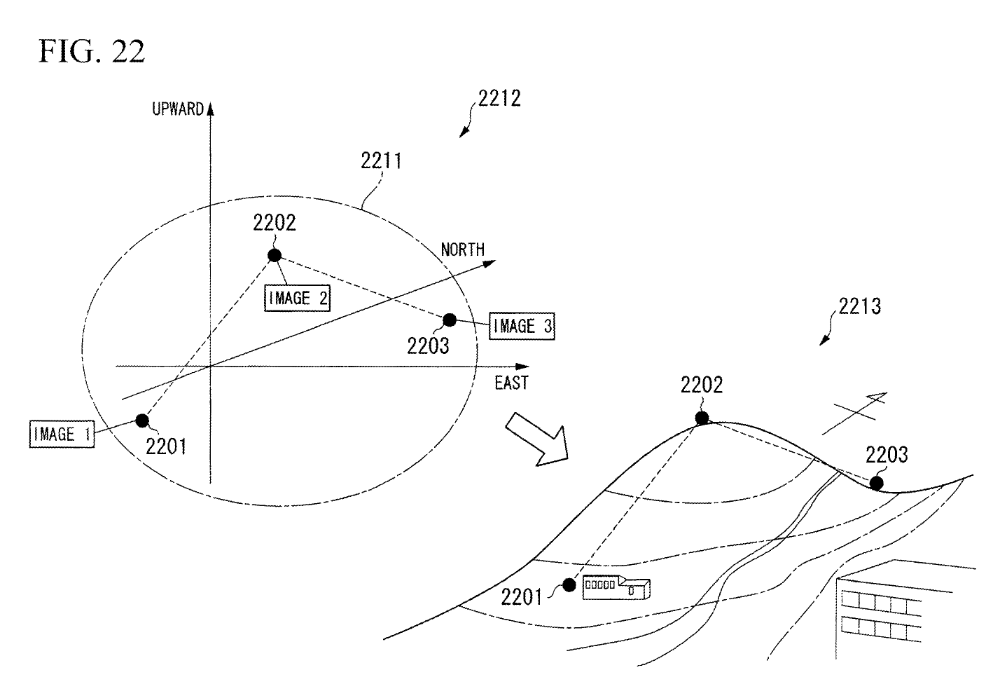

Using FIG. 22, a method of arranging an image in an appropriate point on a map based on the position relationship between relative positions (coordinates) will be described.

The relative position (coordinates) relationship 2212 of an image group 2211 is as illustrated in the drawing. The image group 2211 includes image 1, image 2, and image 3, and has position information of respective positions 2201, 2202, and 2203. On the other hand, a map 2213 includes altitude information, and thus three-dimensional topographical information can be expressed.

In the case of arranging the image group 2211 on the map 2213 as illustrated in FIG. 22, positions that are most appropriate to the terrain while maintaining the position relationship of the images are obtained from the position relationship in which each image of the image group 2211 is photographed and the topographical information on the map 2213, and each image is arranged in the obtained position. According to this method, an accurate position on the map can be exactly specified through a calculation even though the images is not arranged in the accurate position on the map by the user, and thus it is possible to add the absolute position information (geo tag) as described above using FIGS. 18 to 21 to the image.

As described above, according to the embodiments of the invention, the movement amount of the camera 100 can be measured and high-precision relative position information that is calculated based on the movement amount can be added to an image. Further, the absolute position of the image captured in the first image capturing position is designated, and the absolute position in the second image capturing position is calculated based on the absolute position and the relative position in the second image capturing position based on the first image capturing position. Further, the designated absolute position information is added to the image captured in the first image capturing position, and the calculated absolute position is added to the image captured in the second image capturing position, so that high-precision absolute position information can be added to the image regardless of the weather, indoors or outdoors, and the zone where photographing spots are closely provided.

While embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image capturing terminal comprising:
an image capturing unit which captures an object and generates an image;
a sensor which acquires information on movement from a first image capturing position to a second image capturing position;
a calculation unit which calculates a relative position of the second image capturing position with reference to the first image capturing position based on the information acquired by the sensor; and
an addition unit which adds information that indicates the relative position to an image captured in the second image capturing position.

2. The image capturing terminal according to claim 1, further comprising:
a designation unit which designates a first absolute position that corresponds to the first image capturing position;
a compute unit which computes a second absolute position based on the first absolute position and the information that indicates the relative position; and
an addition unit which adds information that indicates the first absolute position to an image captured in the first image capturing position and adds information that indicates the second absolute position to an image captured in the second image capturing position.

3. A data processing terminal comprising:
a storage unit which stores a first image captured in a first image capturing position and a second image to which information that indicates a relative position with reference to the first image capturing position is added;
a designation unit which designates a first absolute position that corresponds to the first image capturing position;
a compute unit which computes a second absolute position based on the first absolute position and information that indicates the relative position; and
an addition unit which adds information that indicates the first absolute position to the first image and adds information that indicates the second absolute position to the second image.

4. The data processing terminal according to claim 3, wherein the designation unit includes a user interface for a user to designate the absolute position.

5. An image capturing method comprising:
acquiring information on a movement from a first image capturing position to a second image capturing position;
generating an image by capturing an object in the second image capturing position;
calculating a relative position of the second image capturing position with reference to the first image capturing position based on the information on the movement from the first image capturing position; and
adding information that indicates the relative position to the image captured in the second image capturing position.

6. An image capturing method comprising:
generating a first image by capturing an object in a first image capturing position;
acquiring information on a movement from the first image capturing position to a second image capturing position;
generating a second image by capturing an object in the second image capturing position;
calculating a relative position of the second image capturing position with reference to the first image capturing position based on the information on the movement from the first image capturing position;
adding information that indicates the relative position to the second image;
designating a first absolute position that corresponds to the first image capturing position;
computing a second absolute position based on the first absolute position and the information that indicates the relative position;
adding information that indicates the first absolute position to the first image; and
adding information that indicates the second absolute position to the second image.

7. A data processing method comprising:
designating a first absolute position that corresponds to a first image capturing position;
computing a second absolute position based on the first absolute position and information that indicates a relative position with reference to the first image capturing position;
adding information that indicates the first absolute position to a first image captured in the first image capturing position; and
adding information that indicates the second absolute position to a second image to which information that indicates the relative position is added.
